(19) United States
(12) Patent Application Publication
(10) Pub. No.: US 2013/0027827 A1
(43) Pub. Date: Jan. 31, 2013

(54) PROTECTION CIRCUIT

(71) Applicants: TING GE, Shenzhen City (CN); YING-BIN FU, Shenzhen City (CN); YA-JUN PAN, Shenzhen City (CN)

(72) Inventors: TING GE, Shenzhen City (CN); YING-BIN FU, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/300,610

(22) Filed: Nov. 20, 2011

(30) Foreign Application Priority Data
Jul. 29, 2011 (CN) 201110215734.8

(51) Int. Cl. H02H 5/04

(52) U.S. Cl. 361/93.8

(57) ABSTRACT

A protection circuit includes an integrated circuit (IC), a peripheral circuit connected to the IC, and a measurement circuit connected to an enable pin of the IC. The peripheral circuit includes at least one element which generates heat. The measurement circuit includes a power supply, a resistor, and a thermistor. The heat from the element raises the temperature of the thermistor and changes a resistance of the thermistor and decreases a voltage of the node. When the voltage of the node is less than or equals to a standard voltage of the enable pin of the IC, the IC and the peripheral circuit stop working.

### BACKGROUND

1. Technical Field

The present disclosure relates to a protection circuit.

2. Description of Related Art

An integrated circuit (IC) may include a protection circuit. The protection circuit would turn off the IC when the temperature of the IC is greater than a standard operating temperature. However, the temperature of elements which generate heat in peripheral circuitries controlled by the IC may be greater than the standard operating temperature. As a result, before the IC shuts down, the elements of the peripheral circuit may be damaged because of the elevated temperature.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of a first embodiment of a protection circuit.

FIG. 2 is a schematic diagram of a second embodiment of a protection circuit.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

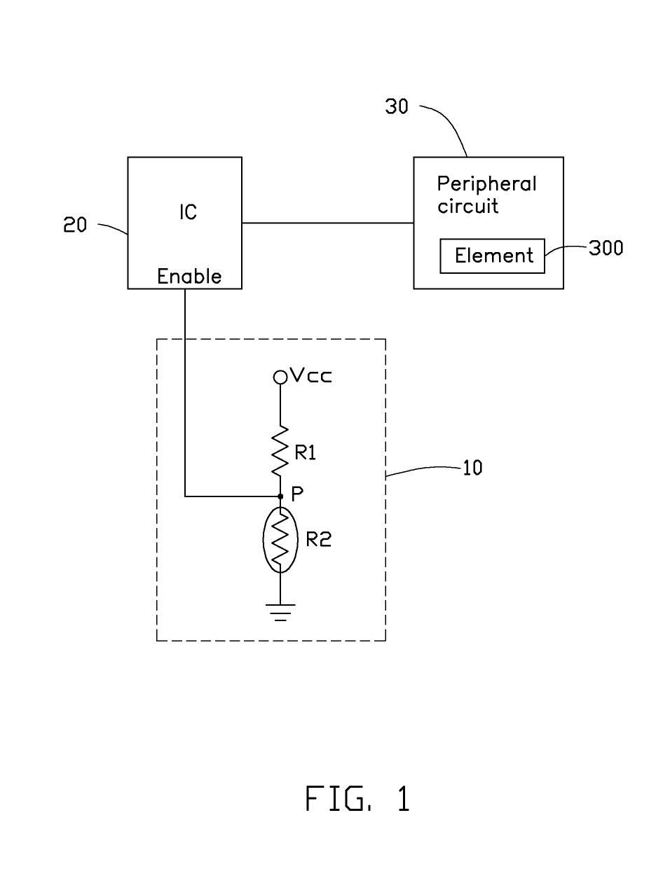

Referring to FIG. 1, a first exemplary embodiment of a protection circuit includes an integrated circuit (IC) 20, a peripheral circuit 30, and a measurement circuit 10. The peripheral circuit 30 and the measurement circuit 10 are both connected to the IC 20. The peripheral circuit 30 includes an element 300, such as a field-effect transistor (FET) or an inductor, either of which generates heat. The measurement circuit 10 is mounted adjacent to the element 300 to measure a temperature of the element.

The IC 20 includes an enable pin for turning on or turning off the IC 20. In the embodiment, when a voltage to the enable pin of the IC 20 is greater than a standard voltage, the IC 20 is in a working state. When the voltage is less than or equal to the standard voltage, the IC 20 stops working. In another embodiment, the enable pin of the IC 20 stops working when the voltage supplied to it is greater than the standard voltage.

The measurement circuit 10 includes a power supply VCC, a resistor R1, and a negative temperature coefficient (NTC) thermistor R2. The power supply VCC is connected to a first terminal of the thermistor R2 through the resistor R1. A second terminal of the thermistor R2 is grounded. A node P between the resistor R1 and the thermistor R2 is connected to the enable pin of the IC 20.

When the IC 20 and the peripheral circuit 30 operate at a normal temperature, the resistor R2 acting as a voltage divider causes the voltage at the node P to be greater than the standard voltage of the IC 20. When the temperature of the element 300 increases, the resistance of the thermistor R2 decreases. As a result, when the temperature of the thermistor R2 is higher than a preset value, the voltage at the node P is less than or equal to the standard voltage of the IC 20. As a result, the IC 20 stops working, in such a way that the peripheral circuit 30 also stops working.

Furthermore, in an embodiment where the IC 20 stops working when the voltage at the enable pin of the IC 20 is greater than the standard voltage, the power supply VCC is connected to a first terminal of the resistor R1 through the thermistor R2. A second terminal of the resistor R1 is grounded. As a result, when the temperature of the element 300 of the peripheral circuit 30 increases, the temperature of the thermistor R2 increases and the voltage at node P increases. Thus when the enable voltage for IC 20 becomes greater than the working voltage, the IC 20 and the peripheral circuit 30 both stop working.

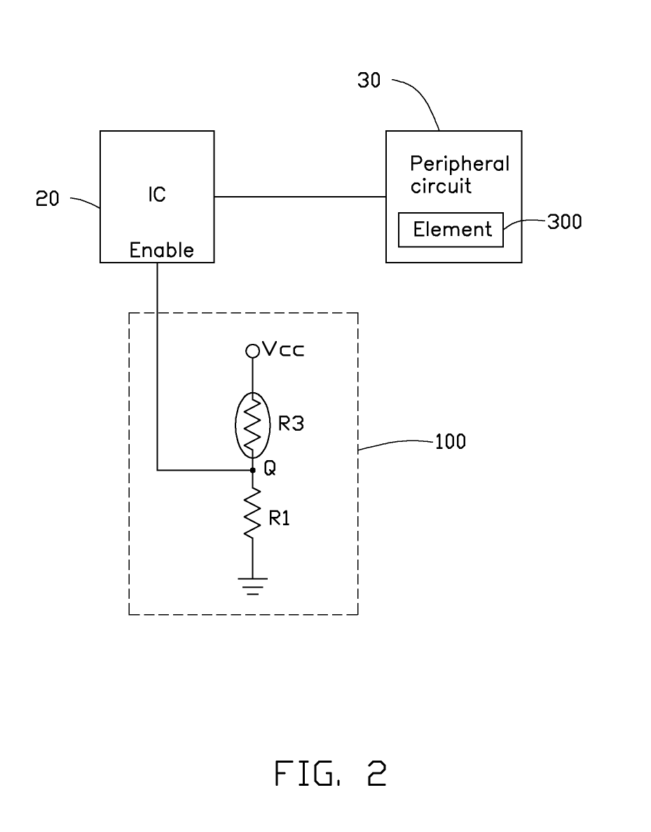

Referring to FIG. 2, a second exemplary embodiment of a protection circuit includes an IC 20 with an enable pin, a peripheral circuit 30, and a measurement circuit 100. The measurement circuit 100 includes a power supply VCC, a resistor R1, and a positive temperature coefficient (PTC) thermistor R3. The power supply VCC is connected to a first terminal of the resistor R1 through the thermistor R3. A second terminal of the resistor R1 is grounded. A node Q between the resistor R1 and the thermistor R3 is connected to the enable pin of the IC 20.

When the IC 20 and the peripheral circuit 30 operate at a normal temperature, the resistor R1 acting a voltage divider causes the voltage at the node Q to be greater than the standard voltage of the IC 20. When the temperature of the element 300 increases, the resistance of the thermistor R3 increases. As a result, when the temperature of the thermistor R3 is higher than the preset value, the voltage at the node Q is less than or equal to the standard voltage of the IC 20. As a result, the IC 20 stops working, in such a way that the peripheral circuit 30 also stops working.

Furthermore, where the IC 20 stops working when the voltage at the enable pin of the IC 20 is greater than the standard voltage, the power supply VCC is connected to a first terminal of the thermistor R3 through the resistor R1. A second terminal of the thermistor R3 is grounded. As a result, when the temperature of the element 300 of the peripheral circuit 30 increases, the temperature of the thermistor R3 increases and the voltage at node Q increases. Thus when the enable voltage for IC 20 becomes greater than the working voltage, the IC 20 and the peripheral circuit 30 both stop working.

The foregoing description of exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A protection circuit comprising:
an integrated circuit (IC) comprising an enable pin;
a peripheral circuit connected to the IC, wherein the peripheral circuit comprises an element which generates heat; and
a measurement circuit connected to the enable pin of the IC, wherein the measurement circuit comprises a power supply, a resistor, and a thermistor, the power supply is grounded through the resistor and the thermistor connected in series, a node between the resistor and the thermistor is connected to the enable pin of the IC, the heat from the element raises the temperature of the thermistor and changes a resistance of the thermistor and decreases a voltage of the node, when the voltage of the node is less than or equals to a standard voltage of the enable pin of the IC, the IC stops working and the peripheral circuit stops working.

2. The protection circuit of claim 1, wherein the thermistor is a negative temperature coefficient thermistor, the power supply is connected to a first terminal of the negative temperature coefficient thermistor through the resistor, a second terminal of the negative temperature coefficient thermistor is grounded.

3. The protection circuit of claim 1, wherein the thermistor is a positive temperature coefficient thermistor, the power supply is connected to a first terminal of the resistor through the positive temperature coefficient thermistor, a second terminal of the resistor is grounded.

4. A protection circuit comprising:
an integrated circuit (IC) comprising an enable pin;
a peripheral circuit connected to the IC, wherein the peripheral circuit comprises an element which generates heat; and
a measurement circuit connected to the enable pin of the IC, wherein the measurement circuit comprises a power supply, a resistor, and a thermistor, the power supply is grounded through the thermistor and the resistor, a node between the resistor and the thermistor is connected to the enable pin of the IC, the heat from the element raises the temperature of the thermistor and changes a resistance of the thermistor and decreases a voltage of the node, when the voltage of the node is greater than a standard voltage of the enable pin of the IC, the IC stops working and the peripheral circuit stops working.

5. The protection circuit of claim 4, wherein the thermistor is a positive temperature coefficient thermistor, the power supply is connected to a first terminal of the positive temperature coefficient thermistor through the resistor, a second terminal of the positive temperature coefficient thermistor is grounded.

6. The protection circuit of claim 4, wherein the thermistor is a negative temperature coefficient thermistor, the power supply is connected to a first terminal of the resistor through the negative temperature coefficient thermistor, a second terminal of the resistor is grounded.
